(19) United States
(12) Patent Application Publication
(10) Pub. No.: US 2025/0216498 A1
(43) Pub. Date: Jul. 3, 2025

(54) SYSTEMS, METHODS, AND DEVICES FOR VEHICLE OCCUPANT DETECTION

(71) Applicant: Allstate Insurance Company, Northbrook, IL (US)

(72) Inventors: PHIL RAMIREZ, Northbrook, IL (US); Ryan Faulkner, Northbrook, IL (US); Brennan Gee, Northbrook, IL (US); Timothy Gibson, Northbrook, IL (US); Anasa Shank, Northbrook, IL (US); Aaron Cruz, Northbrook, IL (US); Harpreet Singh, Northbrook, IL (US); Alexandria Valentine, Northbrook, IL (US)

(21) Appl. No.: 19/001,718

(22) Filed: Jan. 9, 2025

Related U.S. Application Data
(60) Provisional application No. 63/615,482, filed on Dec. 28, 2023.

(51) Int. Cl. G01S 5/02; G01S 1/04; H04B 17/318; H04W 4/48; H04W 4/80

(52) U.S. Cl. CPC G01S 5/0231; G01S 1/0428; G01S 5/021; H04B 17/318; H04W 4/48; H04W 4/80

(57) ABSTRACT

Implementations described herein provide systems, methods, and devices for vehicle occupant detection based on wireless transmission(s) from one or more wireless transmitter devices (e.g., beacons) located in the vehicle. The wireless transmitter devices can be standalone devices, such as portable low energy beacons, and/or the wireless transmitter devices can be integrated into other components of the vehicle, such as an on-board dash computer or a door handle. The systems disclosed herein receive the wireless transmission and determine transmission metrics associated with the transmission, such as a signal strength value or a transmission angle. A driver status determination and/or a passenger status determination is based on the transmission metrics. A data file converter generates a driver status data file representing the driver status determination and/or the passenger status determination. The driver status data file is sent to an application for which the driver status data file is configured.

### CROSS-REFERENCE TO RELATED APPLICATIONS

The present application claims priority to U.S. Provisional Patent Application No. 63/615,482 filed on Dec. 28, 2023, which is incorporated by reference in its entirety herein.

### FIELD

Aspects of the present disclosure relate to systems for vehicle occupant detection and more particularly, to detecting a driver status.

### BACKGROUND

Vehicles typically include a variety of vehicle computing devices that establish wireless network connections with mobile devices of vehicle occupants. For instance, vehicle computing devices may establish Bluetooth® connections with the mobile devices. The mobile devices of the vehicle occupants typically use the wireless transmissions from the vehicle computing devices to establish network connections so that data can be transmitted back and forth between the vehicle computing devices and the mobile devices. This is a computationally heavy process which requires significant network resources.

It is with these observations in mind, among others, that aspects of the present disclosure were conceived and developed.

### SUMMARY

Implementations described and claimed herein address the foregoing by providing systems and methods for vehicle occupant detection. For example, a vehicle occupant detection system can include a wireless receiver device obtaining a plurality of wireless transmissions from one or more wireless beacon devices positioned in a vehicle; a controller having at least one processor, the controller determining one or more transmission metric values associated with the plurality of wireless transmissions. The one or more transmission metric values can correspond to a driver status determination. Furthermore, a driver status data file, generated by the controller, can indicate the driver status determination, and the driver status data file can be configured for reception by an application in communication with the controller.

In some examples, the plurality of wireless transmissions can include one or more of an inquiry request, a discovery request, a pairing request, or a paging request. Also, the one or more wireless beacon devices can include a plurality of Bluetooth® low energy beacon devices having a predefined transmission arrangement in the vehicle, and the driver status determination can be based on determining whether the one or more transmission metric values meets a threshold profile value associated with the predefined transmission arrangement. Additionally, the threshold profile value can include a data structure, accessible by the controller, representing one or more expected signal strength values of the plurality of Bluetooth® low energy beacon devices, and the driver status determination can be based at least partly on the one or more expected signal strength values. The threshold profile value can also include a data structure, accessible by the controller, representing one or more of an expected angle of departure value or an expected angle of arrival value for the plurality of wireless transmissions, and the driver status determination can be based at least partly on the expected angle of departure value or the expected angle of arrival value.

In some instances, the driver status determination can be based at least in part on the plurality of Bluetooth® low energy beacon devices being positioned in the vehicle at two or more of: a driver side dash location, a passenger side dash location, a driver side rear location, or a passenger side rear location. Furthermore, determining the one or more transmission metric values can include detecting a recurring connection pattern with a short-range, low energy beacon device at the driver side dash location, the driver side rear location, and/or a driver side door handle location. The one or more wireless beacon devices can be integrated into one or more of an onboard vehicle dash device or a door handle device. Moreover, the one or more transmission metric values can include a first signal strength value associated with a first wireless beacon positioned in the vehicle, and/or a second signal strength value associated with a second wireless beacon positioned in the vehicle. The second signal strength value can be lower than the first signal strength value. Additionally, the plurality of wireless transmissions can include a periodic ping request to establish a network connection from the one or more wireless beacon devices.

In some scenarios, a vehicle occupant detection system can include one or more processors; and/or a computer-readable non-transitory memory device storing instructions that, when executed by the one or more processors, cause the vehicle occupant detection system to: receive, using a wireless receiver interface, one or more wireless transmissions from one or more wireless beacons positioned in a vehicle; determine, using a controller, one or more transmission metric values associated with the one or more wireless transmissions, the one or more transmission metric values corresponding to a driver status determination; and/or generate a driver status data file indicating the driver status determination and configured for reception by an application in communication with the controller.

In some instances, the instructions, when executed by the one or more processors, can further cause the vehicle occupant detection system to perform a driver detection calibration process by: determining an identifier associated with a user of a mobile device including the wireless receiver interface; establishing a network connection between the mobile device and at least one of the one or more wireless beacons; and/or receiving a manual input at the mobile device to confirm a driver status associated with a transmission metric of the network connection. The vehicle occupant detection system can further include one or more near field communication tags positioned in the vehicle associated with a designated mobile device receiver area, wherein determining the one or more transmission metric values can include determining that a mobile device is placed in the designated mobile device receiver area. Additionally, the instructions, when executed by the one or more processors, can further cause the vehicle occupant detection system to present an indication, at a display of the mobile device, of the designated mobile device receiver area associated with the one or more near field communication tags designated to the driver status. Moreover, the instructions, when executed by the one or more processors, can further cause the vehicle occupant detection system to send the driver status data file to the application in communication with the controller based at least partly on a permissions action of the application. Furthermore, the application can include one or more of a public transportation ticketing application, a ride sharing application, or an insurance application.

In some examples, a method of vehicle occupant detection can include receiving, using a wireless receiver interface of a computing device, one or more wireless transmissions from one or more wireless beacons positioned in a vehicle; determining, using a controller of the computing device, one or more transmission metric values associated with the one or more wireless transmissions, the one or more transmission metric values corresponding to a driver status determination; and/or generating a driver status data file indicating the driver status determination and configured for reception by one or more applications in communication with the controller.

In some scenarios, the one or more wireless transmissions can include a request to establish a network connection; and/or generating the driver status data file includes a data conversion procedure performed by: converting signal strength data or signal angle data from the request to establish the network connection into the one or more transmission metric values, and/or converting the one or more transmission metric values into the driver status data file formatted for reception by the one or more applications. Furthermore, the data conversion procedure can omit, avoid, and/or lack establishing the network connection with the one or more wireless beacons responsive to the request. Moreover, the method can further include receiving device activity data from the one or more applications including a user behavior indicator, wherein generating the driver status data file can include performing a data verification procedure by comparing the user behavior indicator to the driver status determination.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 illustrates an example vehicle occupant detection system using one or more wireless beacons.

FIGS. 2A-2C illustrate an example system including a vehicle occupant detection system using one or more threshold profile values of a predefined transmission arrangement, which can form at least a portion of the example system of FIG. 1.

FIG. 3 illustrates an example vehicle occupant detection system including a data file converter for generating and/or sending a driver status data file, which can form at least a portion of the example system of FIG. 1.

FIG. 4 illustrates an example network environment for implementing a vehicle occupant detection system, which can form at least a portion of the example system of FIG. 1.

FIG. 5 illustrates an example computing system for implementing a vehicle occupant detection system, which can form at least a portion of the example system of FIG. 1.

FIG. 6 illustrates an example method of vehicle occupant detection, which can be performed by any of the example systems depicted in FIGS. 1-5.

### DETAILED DESCRIPTION

Aspects of the presently disclosed technology generally relate to systems, methods, and devices systems, methods, and devices for vehicle occupant detection based on wireless transmissions from one or more wireless transmitter devices located at the vehicle. An occupant detection system can receive the wireless transmissions from one or more wireless transmitter devices, which can be standalone devices placed in the vehicle, such as portable low energy Bluetooth® 5.1 beacons. Additionally or alternatively, the wireless transmitter devices can be integrated into other components of the vehicle, such as an on-board dash computer or a door handle. These wireless transmissions can send or push periodic messages or pings from the wireless transmissions for purposes of discovering and/or connecting with any device that comes within range of the wireless transmitting device. The systems, methods, and devices disclosed herein can determine additional information from these wireless transmissions, beyond simply establishing a connection, from which a driver status data file associated with the computing device can be generated.

As such, the disclosed technology can provide a highly efficient networking and data processing architecture for converting wireless transmissions into driver status data files. Generating transmission metric data based on the wireless transmission themselves, rather than using the wireless transmission messages to establish a connection, means the systems can use already existing wireless transmissions, reducing hardware requirements in some scenarios. The systems can create an additional data analytics layer that uses transmission metrics from the wireless transmissions in addition to or alternatively to the initial purpose of the wireless transmission-to establish a connection and share data with the computing device. Furthermore, the systems can include a data file converter, with permissions control and data verification components, to generate the driver status data file, which can be efficiently sent to a wide variety of applications for many beneficial uses.

Additional advantages of the disclosed technology will become apparent from the detailed description below.

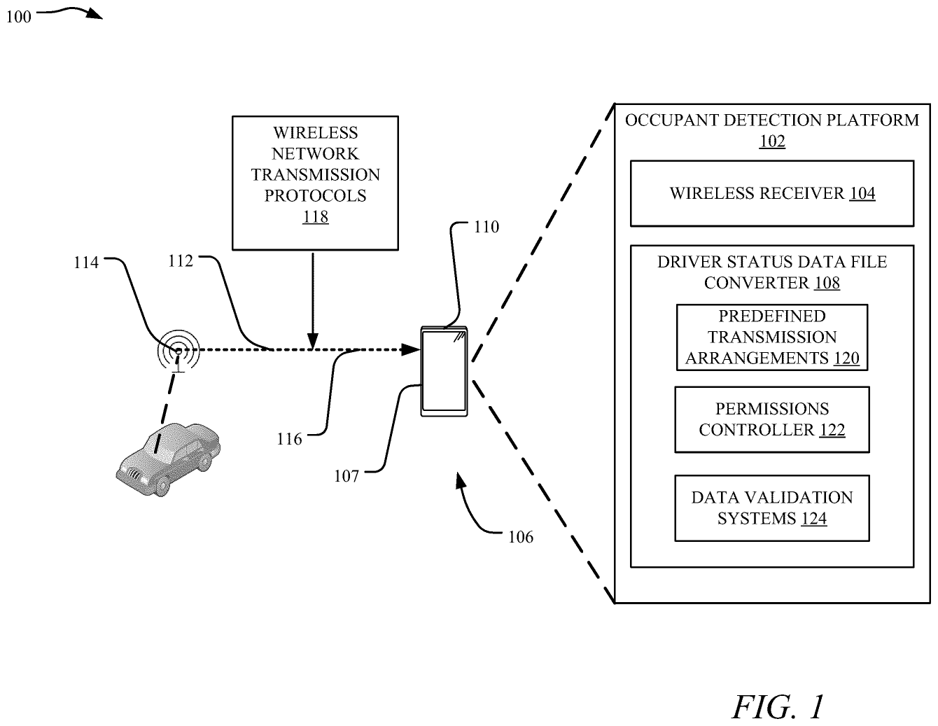

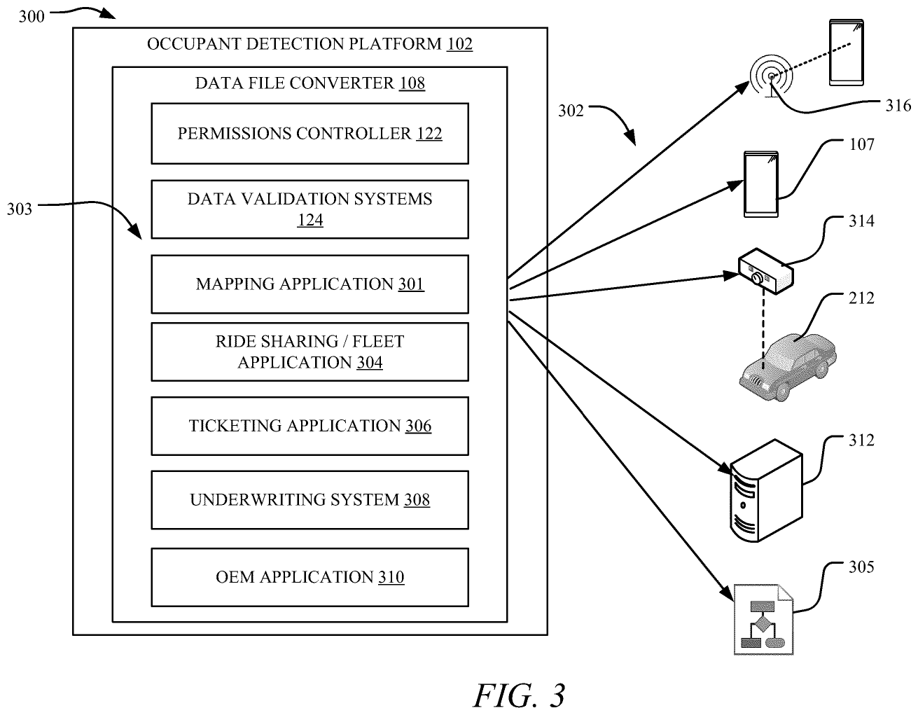

To begin a detailed description of an example vehicle occupant detection system 100, reference is made to FIG. 1. In one implementation, the example vehicle occupant detection system 100 includes an occupant detection platform 102 for receiving data from various data sources to detect vehicle occupants and/or a status of vehicle occupants. For instance, the occupant detection platform 102 can include a wireless receiver 104 of a computing device 106 (e.g., a mobile device 107) storing and/or executing the occupant detection platform 102. The occupant detection platform 102 can also include a driver status data file converter 108 which, upon execution of one or more processors of a controller 110 of the computing device 106, can convert data related to one or more wireless transmissions 112 from one or more wireless beacon devices 114 into a driver status data file 302 (e.g., see FIG. 3).

For instance, the vehicle occupant detection system 100 can determine one or more transmission metric values 116 associated with the one or more wireless transmissions 112. The one or more wireless beacon devices 114 can include one or more Bluetooth® low energy beacons, which can send the one or more wireless transmissions 112 using one or more wireless transmission protocols 118 for sending a periodic ping request to establish a network connection (e.g., Bluetooth® 5.1 protocols). In some examples, the wireless transmission protocols 118 can be used to send the wireless transmissions 112 as one or more of an inquiry request, a discovery request, a pairing request, a paging request, combinations thereof, and/or other request messages attempting to establish communication with the computing device 106.

In some examples, the wireless receiver 104 of the computing device 106 can receive these one or more wireless transmissions 112 unprompted and/or as push messages received at the wireless receiver 104. The occupant detection platform 102 can determine the one or more transmission metric values 116 without accepting the request to establish the network connection and/or without responding to the one or more wireless beacon devices 114. For instance, the occupant detection platform 102 can determine a received signal strength value associated with wireless transmission(s) 112, such as a received signal strength indicator (RSSI). Additionally or alternatively, the occupant detection platform 102 can determine an angle of departure value and/or an angle of arrival value of the wireless transmission(s) 112. These transmission metric values 116 can be compared to one or more predefined transmission arrangements 120, as discussed in greater detail below. The one or more wireless transmissions 112 can be received from devices operating on a Bluetooth® network, a CarPlay network, a Wi-Fi network, a near field communication network, or so forth. Additionally or alternatively, transmission metric values 116 can be determined from wired networks, such as a USB network connection.

Furthermore, the occupant detection platform 102 can include a permission controller 122 for establishing and/or managing the permissions and data communications between the occupant detection platform 102 and other applications communicating with the controller (e.g., other applications on the mobile device 107). These communications with other applications can be used to receive the data related to the one or more wireless transmissions 112, for instance, from another application providing a Bluetooth® protocol communication interface. Additionally or alternatively, the data from the other applications can be used by a data validation system 124 to verify or validate a driver status determination made by the occupant detection platform 102. The driver status data file 302 can be sent to these applications using the same permission controller 122 and/or other communication channels.

As discussed herein, the occupant detection platform 102 can be used to detect a vehicle's occupants by monitoring the proximity of a user's mobile device 107 to a low-energy beacon, or beacons 114. One or more communications can be triggered based on a proximity threshold being met. The one or more communications can include a validation indication of whether a device is associated with a vehicle driver, a ride share, or an alternative transportation method. Additionally or alternatively, the communication(s) can include a permission request for access to nearby applications, such as Bluetooth, vehicle OEM applications, and/or CarPlay. The communication(s) can be based on additional insights gathered through the wireless connection to nearby applications. In some scenarios, the occupant detection platform 102 can determine data corresponding to a driver status, along with additional insights through the wireless connection to nearby applications. In this way, the occupant detection platform 102 can be used determine insurance rating and eligibility, for instance, by determining driving patterns, detection of undisclosed drivers, and/or phone handling. Vehicle information and/or driving behavior information can also be determined through a direct OEM connection.

Furthermore, a device-to-beacon proximity trigger can be a precursor to requesting access to the nearby applications. In some scenarios, other proximity-based triggers can be used as a precursor or prerequisite for accessing nearby applications and/or vehicle data, such as a direct Bluetooth or wireless connection with the vehicle. This data can additionally be used for risk/insurance ratings and/or underwriting.

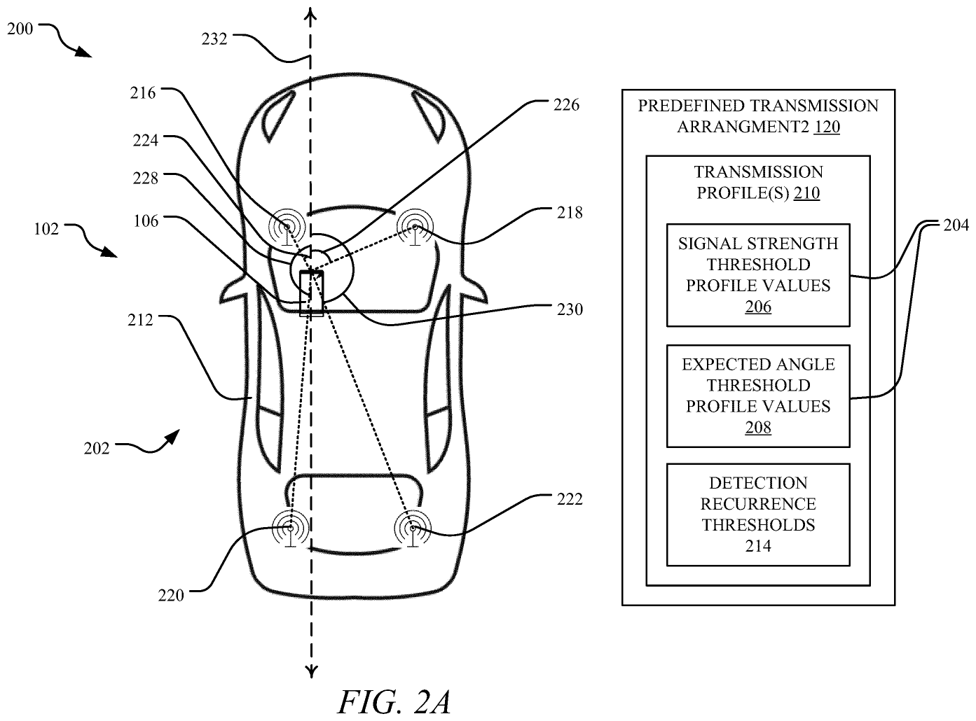

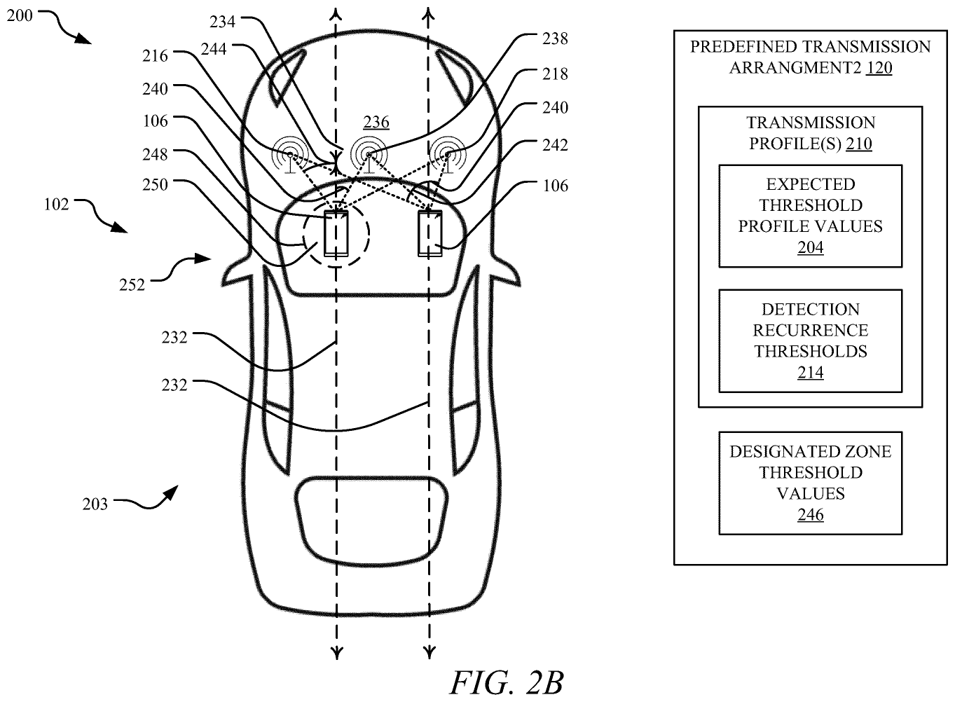

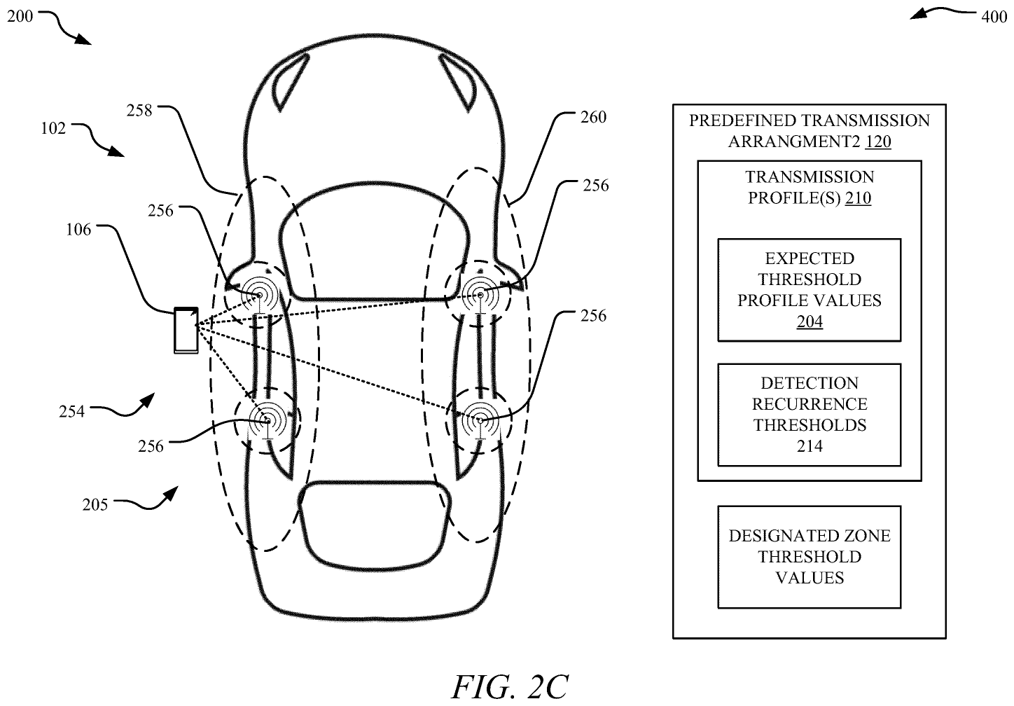

FIGS. 2A-2C depict example vehicle occupant detection system(s) 200 which use one or more predefined transmission arrangements 120 to make a driver status determination. The vehicle occupant detection system(s) 200 depicted in FIGS. 2A-2C can be similar to, identical to, or can form at least a portion of the system 100 depicted in FIG. 1.

In some examples, the system(s) 200 can include a first predefined transmission arrangement 202 including expected transmission values 204, for a plurality of wireless beacon devices 114, corresponding to a driver status and/or a passenger status. For instance, the first predefined transmission arrangement 202 can include a plurality of expected signal strength threshold profile values 206 (e.g., or ranges) and/or expected angle threshold profile values 208 (e.g., departure angle values or ranges and/or arrival angle values or ranges) associated with different wireless beacon devices 114, the collection of which can correspond to a transmission profile 210. The transmission profile 210 can be a unique data file formed by the aggregated combination of different expected value thresholds/ranges which, together, indicate a particular status, such as the driver status or the passenger status. The expected values of the transmission profile 210 can be compared to the measured values of signal strength (e.g., the transmission metric values 116) from the wireless receiver 104 to determine whether or not the measured values match those of the transmission profile 210. If these transmission metric values 116 match—e.g., are above or below a threshold and/or are within a range—the expected signal strength threshold profile values 206 and/or the expected angle threshold profile values 208, the occupant detection platform 102 can make a driver status determination that the computing device 106 belongs to a driver of the vehicle 212 (e.g., within a certain error range such as 90%, 95%, or 99% likelihood). Moreover, the expected transmission values 204 (e.g., the expected signal strength threshold profile values 206 and/or the expected angle threshold profile values 208) can be used to determine a passenger status of an occupant, for instance, by matching one or more passenger status expected values of a passenger status transmission profile. The expected transmission values 204 can also be used to determine a null result for the transmission profile 210 corresponding to the driver status, which can correspond to a passenger status determination.

In some instances, the transmission profile 210 can include one or more detection recurrence thresholds 214. For example, the occupant detection platform 102 can determine a certain number of occurrences or a repetition of one or more transmission metric values 116 occurring in a periodic manner (e.g., occurring daily, weekly, within a certain time range each day), on weekdays, on weekends, and/or combinations thereof). Matching a number of occurrences (e.g., three days in a row) of a particular signature of one or more transmission metric values 116 can indicate a consistent placement and/or movement of the computing device 106 in the vehicle 212, which the occupant detection platform 102 can use to determine the driver status (e.g., as one or more factors or weighted values).

In some scenarios, the first predefined transmission arrangement 202 can correspond to an arrangement of wireless beacon devices 114 including four wireless beacon devices 114 distributed throughout the vehicle 212 at a driver front/dash location 216, a passenger side front/dash location 218, a driver side rear location 220, and/or a passenger side rear location 222. These beacon locations can correspond to the different expected signal strength threshold profile values 206 and/or the expected angle threshold profile values 208. For instance, the driver/front dash location 216 can have a first expected signal strength value and/or a first expected angle 224; the passenger dash location 218 can have a second expected signal strength value and/or a second expected angle 226; the driver side rear location 220 can have a third expected signal strength value and/or a third expected angle 228; and/or the passenger side rear location 222 can have a fourth expected signal strength value and/or a fourth expected angle 230. The various expected angle threshold profile values 208 can be measured according to a reference axis 232 of the computing device 106, and/or relative to one of the wireless transmissions 112 selected to be a reference axis (e.g., based on a highest signal strength value).

In some examples, the occupant detection platform 102 can base the one or more predefined transmission arrangements 120 on a signal path loss model to determine a distance estimate based on the signal strength. The path loss model can use an inverse square calculation to account for the signal strength loss. In some examples, the Bluetooth® signal strength values can be used to calculate centimeter and/or meter distances, and/or the near field communication values can be used to calculate millimeter and/or centimeter distances.

Turning to FIG. 2B, a second predefined transmission arrangement 203 is depicted. It is to be understood the second predefined transmission arrangement 203 can be combined with or form at least a portion of the first predefined transmission arrangement 202 and/or the third predefined transmission arrangement 205 depicted in FIG. 2C.

In some examples, the second predefined transmission arrangement 203 can include expected transmission values 204 for a plurality of wireless beacon devices 114 arranged along a side 234 of the vehicle 212. For instance, a front side 236 of the vehicle 212 and/or integrated into an onboard vehicle dash 235 and can include the wireless beacon devices 114 having the driver front/dash location 216 and the passenger front/dash location 218, as well as one or more middle locations 238 distributed between end locations. The different locations can each have different expected transmission values 204 corresponding to the driver status and/or the passenger status. For instance, the expected transmission values 204 can include a first transmission angle 240 and/or a second transmission angle 242 which can indicate the transmissions 112 from these wireless beacon devices 114 are from the one or more middle locations 238 and/or the passenger front/dash location 218 relative to the current position of the computing device 106. Moreover, a third transmission angle 244 can indicate the one or more wireless transmissions 112 originates from the driver/front dash location 216 relative to the current position of the computing device 106. Any number of beacon locations can be used with any number of expected angle threshold profile values 208 and/or expected signal strength threshold profile values 206, such that the location of the computing device 106 within the vehicle 212 can be determined with respect to the driver status or the passenger status with a high degree of accuracy.

In some scenarios, the predefined transmission arrangements 120, such as the second predefined transmission arrangement 203 depicted in FIG. 2B, can include a designated zone threshold value 246 corresponding to a designated area 248 in the vehicle. The designated area 248 can be an area of the vehicle 212 designated for receiving a computing device 106 associated with the driver or the passenger. For instance, one or more near field communication device(s) 250 devices (e.g., with millimeter-scale or centimeter-scale transmission ranges) can be disposed adjacent and/or below the designated area 248. As such, the designated zone threshold value 246 can include a predefined detection of a signal from the near field communication device(s) 250, and/or an expected signal strength threshold profile value 206 or an expected angle threshold profile value 208. In some scenarios, detection of the computing device 106 in the designated area 248 can be used to trigger a message to the computing device 106 indicating the designated area 248 associated with the near field communication device(s) 250 to alert the user of its presence. For example, an indication of the designated mobile device receiver area can be presented at a display of the mobile device 107 as a textual or visual cue), and/or as an audio output.

Furthermore, in some instances, the computing device 106 can perform one or more driver detection calibration procedures 252. The calibration procedures 252 can be used to address fragmentation issues caused by differences in the transmission chips (e.g., Bluetooth® chip), radio circuitry antenna, and other components of the computing device which can affect the received signal level. For instance, the occupant detection platform 102 can determine an identifier associated with the computing device 106 and/or a user of the mobile device 107, for instance, via a manual user input at the computing device 106 entering user credentials, or via a message from the computing device 106 (e.g., including a device identifier, a MAC address, a username, etc.). Upon initiating the one or more driver detection calibration procedures 252, the computing device 106 can establish a network connection with and/or can receive the one or more wireless transmissions 112 from the wireless beacon devices 114. The occupant detection platform 102 can receive a manual input (e.g., at the mobile device 107) confirming a driver status associated with the position of the computing device 106 in the vehicle 212 during the calibration procedure and can collect the measured transmission metric values 116 responsive to receiving the manual input confirming the driver status. These one or more transmission metric values 116 collected during the one or more driver detection calibration procedures 252 can be converted into the one or more predefined transmission arrangements 120. This process can occur once and/or can be repeated and averaged to generate a calibrated predefined transmission arrangements 120. Transmission events occurring after the one or more driver detection calibration procedures 252 can be matched to the calibrated predefined transmission arrangements 120. Additionally, when the designated area 248 is used, the occupant detection platform 102 can cause the computing device 106 to present an indication of the designated area 248 (e.g., at a display of the mobile device 107) responsive to the placement in the designated area 248.

FIG. 2C depicts an example one or more predefined transmission arrangements 120, such as a third predefined transmission arrangement 205 including an entry pattern profile 254. It is to be understood that the third predefined transmission arrangement 205 can be combined with or form at least a portion of the first predefined transmission arrangement 202 and/or the second predefined transmission arrangement 203.

In some examples, the third predefined transmission arrangement 205 can include one or more wireless beacon devices 114 integrated into one or more door handle devices 256 or other vehicle components (e.g., seats, seatbelts, center consoles, door interior). Furthermore, the wireless beacon devices 114 can be divided into driver side beacons 258 and/or passenger side beacons 260. The third predefined transmission arrangement 205 can include the entry pattern profile 254 including expected signal strength threshold profile values 206 being greater for the driver side beacons 258 than the passenger side beacons 260 for the driver status determination. Additionally, the entry pattern profile 254 can include the expected transmission values 204 to be greater for the passenger side beacons 260 than the driver side beacons 258 for the passenger status determination. Furthermore, a detection of the signal strength getting greater at the driver side location, peaking, then becoming lower as the computing device 106 enters the vehicle, can indicate a motion of the computing device 106 entering the vehicle 212 through the driver side door. The entry pattern profile 254 can also include expected angle threshold profile value(s) 208 as the computing device 106 passes by the wireless beacon devices 114, such as a wider range of angles for the driver side beacons 258 than the passenger side beacons 260.

FIG. 3 depicts an example vehicle occupant detection system 300 including the data file converter 108 for generating and/or sending a driver status data file 302. The vehicle occupant detection system 300 depicted in FIG. 3 can be similar to, identical to, or can form at least a portion of the system 100 depicted in FIG. 1.

In some examples, the vehicle occupant detection system 300 can include the permission controller 122 for establishing and/or managing the permissions and data communications between the occupant detection platform 102 and other applications 303 communicating with the controller. The permission controller 122 can include and/or has access to one or more application programming interface (API) libraries, which can be organized into data structures particular to a phone manufacturer, an operating system, and/or the corresponding permission setting structures for those operating systems and app stores. Moreover, the permission controller 122 can cause one or more prompts for a permission to be presented at the permission controller 122 so that the occupant detection platform 102 can access the other applications on the computing device 106. The one or more prompts can include a request for location tracking permission, scan permission, and/or connect permission, and other access permissions. The other applications 303 can relate to the near field communication network, the Bluetooth® network, the vehicle OEM, CarPlay, or other vehicle-specific or driver-specific software. The data from the other applications 303 can have multiple uses, such as data validation procedures performed by the data validation system 124, and for providing the formatting structure for the driver status data file 302, such that the driver status data file 302 is configured for reception by the other applications. Additionally, the applications 303 can include a device power management application, which can be used when the computing device 106 is placed near a wireless charging station associated with the device power management application.

In some scenarios, additionally or alternatively, the data validation system 124 can verify or validate a driver status determination-related data such as the driver status data file 302. Moreover, the data validation system 124 can verify and/or validate the one or more transmission metric values 116 and various other factors or sub-components of the driver status determination discussed herein. For instance, the data validation system 124 can receive GPS or location data from another application (e.g., a mapping application 301), which can be compared to a determination of the location of the computing device 106, for instance, moving via the entry pattern profile 254. A time or duration of the determined driver status can be compared to a time or duration of driver status, or other driver/user activity data, received from a ride sharing and/or fleet application 304. Additionally or alternatively, the occupant detection platform 102 can be used in communication with a ticketing application 306 or other type of application related to public transportation. For example, the occupant detection platform 102 can be used to detect airplane passengers, bus passengers, ride sharing passengers, smart bike passengers, etc., and can compare times/durations of trips detected via the wireless beacon devices 114 with those provided by the ticketing application 306 or other public transportation application. Moreover, the data validation system 124 can receive user activity data from an underwriting system application 308 (e.g., an insurance-related application), which can be used to verify driver status determinations, as well as to detect undisclosed drivers. Also, the data validation system 124 can receive user activity data and/or vehicle data from an OEM application 310, such as a vehicle application associated with a vehicle manufacturer and/or vehicle software provider. This OEM data, such as login data, trip data, location data, application usage data, and so forth, can also be compared to the driver status determined by the data validation system 124.

In some examples, the data file converter 108 can convert the driver status determination into the driver status data file 302 configured for reception by one or more of the other application. For example, the permission controller 122 can send and receive various API calls 305 with the other applications 303 to provide the driver status data file 302 to the other applications 303. As noted above, the permission controller 122 can perform various permissions and/or authentication exchanges with the other applications 303 and the OS hosting the applications 303, such that the occupant detection platform 102 can communicate with the other applications 303 responsive to these permissions actions, seamlessly, and/or in the background operations of the computing device 106. As such, the driver status data file 302 can be formatted as a message with particular headers structure, body structures, request lines, endpoints, or other protocol formatting components particularized for the intended recipient application. The occupant detection platform 102 can store and/or manage a database including the API libraries and/or formatting requirements for the different applications 303 and/or device operating systems.

In some scenarios, responsive to generating the driver status data file 302, performing the permissions actions, establishing communication with the other applications 303, and/or formatting the driver status data file 302 for the other applications 303, the one or more wireless transmission protocols 118 can output the driver status data file 302 to the other applications 303. For example, the data file converter 108 can output the driver status data file 302 to any of the other applications 303 on the mobile device 107, such as the ride sharing and/or fleet application 304. This can include a confirmation notification of driver status, passenger status, and/or trip duration. The driver status data file 302 sent to the ride sharing and/or fleet application 304 can include an indication that a user has driven for a predefined amount of time and/or may need a break due to fatigue. Also, the driver status data file 302 can be used by the receiving application 303 to trigger a GPS checkpoint for a location of interest. For example, an indication that the driver has left the vehicle 212 (e.g., no longer has the driver status determination) can trigger a recording of the particular business or location of the computing device 106.

Additionally or alternatively, the driver status data file 302 can be outputted to the ticketing application 306, for instance, as verification of the user's location on a bus or airplane, and/or for pay-per-mile use cases. Moreover, the driver status data file 302 can be outputted to the underwriting system application 308 or other third-party applications, for example, to claim a reward, adjust a premium value, adjust a pay-per-mile calculation, perform a risk-related calculation associated with a vehicle 212 and/or the occupants of the vehicle 212, generate an advertisement, and so forth. For instance, the occupant detection platform 102 can determine driver status durations, driving patterns (e.g., commutes and/or driver identities), which can be used to adjust premiums, provide discounts, detect undisclosed drivers of the vehicle 212, and so forth. Moreover, the driver status data file 302 can be used to determine which driver of a family (e.g., a high risk 16 year old or more experienced driver) is driving the vehicle 212. Moreover, the driver status data file 302 can be received and/or used by a phone handling application to identify and/or confirm phone locking, unlocking, and/or usage while driving.

As discussed in greater detail below, any of these applications 303 receiving the driver status data file 302 can operate at the computing device 106 (e.g., the mobile device 107). Additionally or alternatively, any of the other applications 303 receiving the driver status data file 302 can be at server device 312 located remotely from the computing device 106, and/or an on-board computer 314 of the vehicle 212. Furthermore, the data file converter 108 can output the driver status data file 302 using the network connection 316 of the one or more wireless transmissions 112. In other words, the occupant detection platform 102 can establish the Bluetooth® connection and can use this Bluetooth® interface to send the driver status data file 302. Furthermore, the data file converter 108 can add a security stamp and/or virtual water seal to the driver status data file 302. The data file converter 108 can assign a digital signature to the driver status data file 302 indicating that the driver status data file 302 has not undergone tampering. For example, a unique identifier or line of code can be embedded in a body or header of the driver status data file 302. As such, the integrity of the driver status data file 302 can be preserved as the driver status data file 302 is used by the downstream applications 303, adding a security layer for the downstream data processes.

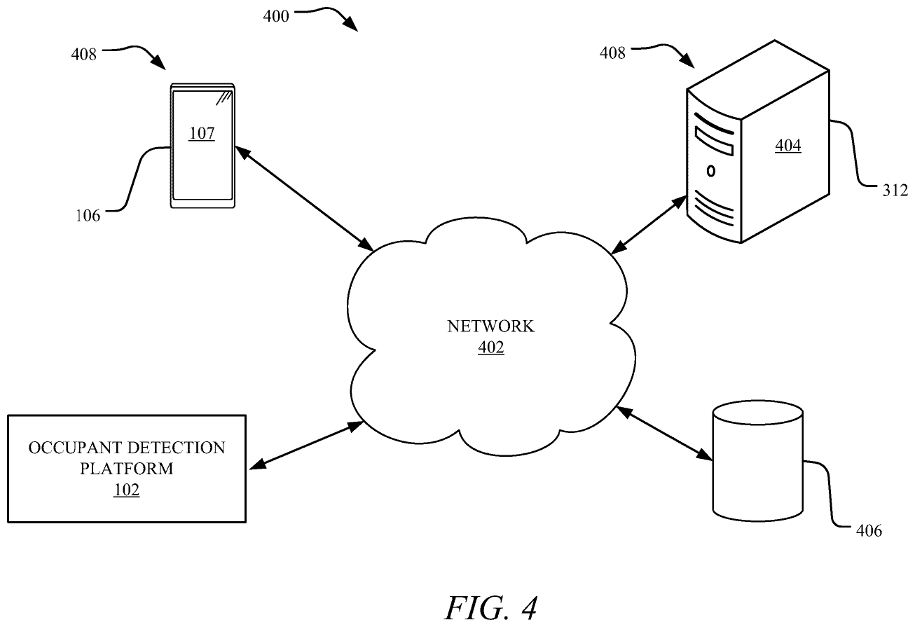

FIG. 4 depicts an example vehicle occupant detection system 400 including a network 402 or network environment for implementing the occupant detection platform 102. The vehicle occupant detection system 400 depicted in FIG. 4 can be similar to, identical to, or can form at least a portion of the system 100 depicted in FIG. 1.

In some examples, the network 402 can connect the occupant detection platform 102 to one or more the host server(s) 404, computing devices 106, database(s) 406, mobile device(s) 107, vehicles 212, on-board computer 314 and/or any other computing system(s) 408 discussed herein.

In some examples, a server device 312 (e.g., a host server 404) can host the network 402. In one implementation, the server device 312 also hosts a website or an application that users may visit to access the occupant detection platform 102, the driver status data file 302 and/or other software components or outputs discussed herein. The server device 312 may be one single server, a plurality of servers with each such server being a physical server or a virtual machine, or a collection of both physical servers and virtual machines. In another implementation, a cloud hosts one or more components of the occupant detection platform 102, such as any of the components discussed herein, individually or in combination with any other components. The occupant detection platform 102, the computing device(s) 106, the server device 312, the other computing system(s) 408, and other resources connected to the network 402 may access one or more additional servers for access to one or more websites, applications, application programming interfaces (API)s, web services interfaces, and/or the like. Additionally or alternatively, any of the components of the occupant detection platform 102 discussed herein, individually or in combination with any other components, can be stored and/or executed at the computing device 106 (e.g., the mobile device 107), the onboard vehicle dash 235, other computing device 106 in the vehicle 212 (e.g., wearable devices or passenger devices), and/or combinations thereof.

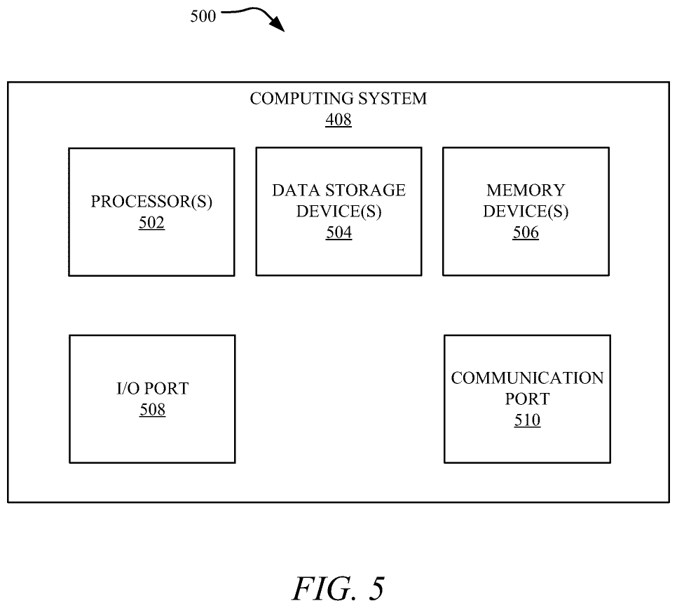

FIG. 5 depicts an example vehicle occupant detection system 500 including the computing system 408 to implement any of the systems 100-400 disclosed herein.

In some examples, referring to FIG. 5, a detailed description of an example vehicle occupant detection system 500 including the computing system 408 having one or more computing units to implement various systems and methods discussed herein is provided. The computing system 408 may include the computing device 106 (e.g., the mobile device 107), the on-board computer 314, other vehicle computing devices, the server device 312, and/or other computing or network devices discussed herein. It will be appreciated that specific implementations of these devices may be of differing possible specific computing architectures.

The computing system 408 may be capable of executing a computer program product to execute a computer process. Data and program files of the occupant detection platform 102 may be input to the computing system 408, which reads the files and executes the programs therein. Some of the elements of the computing system 408 are shown in FIG. 5, including one or more hardware processors 502, one or more data storage devices 504, one or more memory devices 506, and/or one or more ports 508-510. Additionally, other elements that will be recognized by those skilled in the art may be included in the computing system 408. Various elements of the computing system 408 may communicate with one another by way of one or more communication buses, point-to-point communication paths, or other communication means.

The processor 502 may include, for example, a central processing unit (CPU), a microprocessor, a microcontroller, a digital signal processor (DSP), a graphics processing unit (GPU), and/or one or more internal levels of cache. There may be one or more processors 502, such that the processor 502 comprises a single central-processing unit, or a plurality of processing units capable of executing instructions and performing operations in parallel with each other, commonly referred to as a parallel processing environment.

The computing system 408 may be a single computer, a distributed computer, or any other type of computer, such as one or more external computers made available via a cloud computing architecture. The presently described technology is optionally implemented in software stored on the data storage device(s) 504, stored on the memory device(s) 506, and/or communicated via one or more of the ports 508-510, thereby transforming the computing system 408 in FIG. 5 to a special purpose machine for implementing the operations described herein, and providing many practical applications for the technology. Examples of the computing system 408 include personal computers, terminals, workstations, mobile devices, smart phones, tablets, laptops, desktop computers, wearable devices (e.g., glasses, headsets, watches, bracelets, necklaces, clothes, epidermal devices, jewelry, etc.), multimedia consoles, gaming consoles, Internet-of-Things (IoT) devices, appliances, set top boxes, combinations thereof, and the like.

The one or more data storage devices 504 may include any non-volatile data storage device capable of storing data generated or employed within the computing system 408, such as computer-executable instructions for performing a computer process, which may include instructions of both application programs and an operating system (OS) that manages the various components of the computing system 408. The data storage devices 504 may include, without limitation, magnetic disk drives, optical disk drives, solid state drives (SSDs), flash drives, and the like. The data storage devices 504 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 506 may include volatile memory (e.g., dynamic random-access memory (DRAM), static random-access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 504 and/or the memory devices 506, which may be referred to as machine-readable media or computer-readable media. It will be appreciated that machine-readable media may include any tangible non-transitory medium that is capable of storing or encoding instructions (e.g., computer-readable instructions) to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computing system 408 includes one or more ports, such as the input/output (I/O) port 508 and the communication port 510, for communicating with other computing, network, or vehicle devices. It will be appreciated that the ports 508-510 may be combined or separate and that more or fewer ports may be included in the computing system 408.

The I/O port 508 may be connected to an I/O device, or other device, by which information is input to or output from the computing system 408. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing system 408 via the I/O port 508. The input devices can also convert signals generated via the occupant detection platform 102 into input data via the I/O port 508. Similarly, the output devices may convert electrical signals received from computing system 408 via the I/O port 508 into signals that may be sensed as output by a human, such as sound, light, and/or touch. The input device may be an alphanumeric input device, including alphanumeric and other keys for communicating information and/or command selections to the processor 502 via the I/O port 508. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

The environment transducer devices can convert one form of energy or signal into another for input into or output from the computing system 408 via the I/O port 508. For example, an electrical signal generated within the computing system 408 may be converted to another type of signal, and/or vice-versa. In one implementation, the environment transducer devices sense characteristics or aspects of an environment local to or remote from the computing system 408, such as, light, sound, temperature, pressure, magnetic field, electric field, chemical properties, physical movement, orientation, acceleration, gravity, and/or the like. Further, the environment transducer devices may generate signals to impose some effect on the environment either local to or remote from the example computing system 408, such as, physical movement of some object (e.g., a mechanical actuator for causing a vehicle action).

In one implementation, a communication port 510 is connected to a network 402 by way of which the computing system 408 may receive network data useful in executing the methods and systems set out herein as well as transmitting information and network configuration changes determined thereby. Stated differently, the communication port 510 connects the computing system 408 to one or more communication interface devices configured to transmit and/or receive information between the computing system 408 and other devices by way of one or more wired or wireless communication networks or connections. Examples of such networks 402 or connections include, without limitation, Universal Serial Bus (USB), Ethernet, Wi-Fi, Bluetooth®, Near Field Communication (NFC), Long-Term Evolution (LTE), and so on. One or more such communication interface devices may be utilized via the communication port 510 to communicate one or more other machines, either directly over a point-to-point communication path, over a wide area network (WAN) (e.g., the Internet), over a local area network (LAN), over a cellular (e.g., third generation (3G) fourth generation (4G), or fifth generation (5G)) network, or over another communication means. Further, the communication port 510 may communicate with an antenna or other link for electromagnetic signal transmission and/or reception.

In an example implementation, vehicle occupant detection software and other modules and services may be embodied by instructions stored on the data storage devices 504 and/or the memory devices 506 and executed by the processor 502.

In the present disclosure, the methods disclosed may be implemented as sets of instructions or software readable by a device, such as the computing system 408. Further, it is understood that the specific order or hierarchy of steps in the methods disclosed are instances of example approaches. It is understood that the specific order or hierarchy of steps in the method can be rearranged while remaining within the disclosed subject matter.

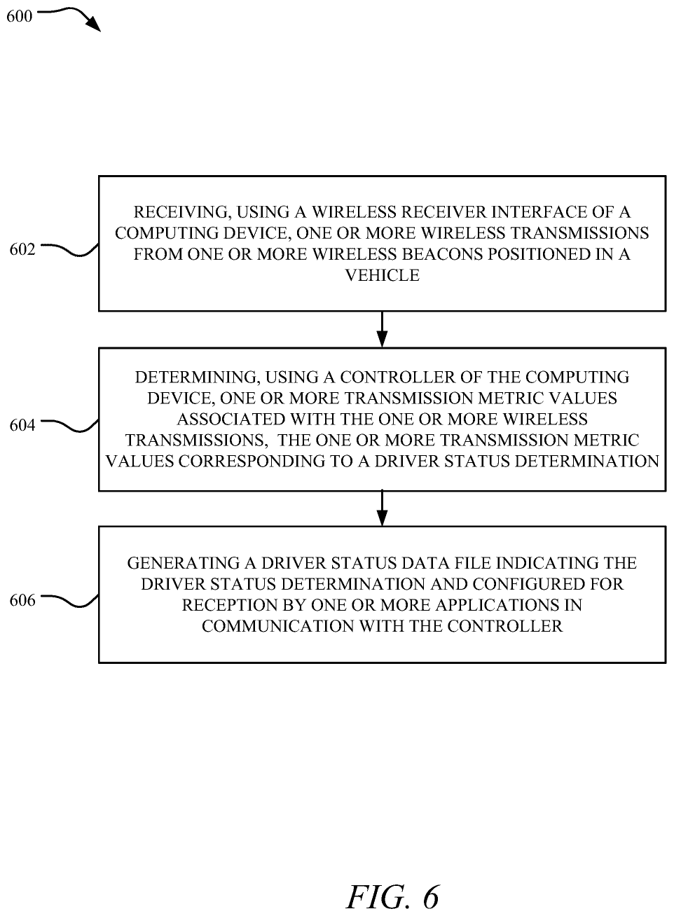

FIG. 6 depicts example operations of a method 600 of vehicle occupant detection are depicted. The method 600 shown in FIG. 6 can be performed by any of the systems 100-500 depicted in FIGS. 1-5.

In some examples, at operation 602, the method 600 can receive, using a wireless receiver interface of a computing device, one or more wireless transmissions from one or more wireless beacons positioned in a vehicle. At operation 604, the method 600 can determine, using a controller of the computing device, one or more transmission metric values associated with the one or more wireless transmissions, the one or more transmission metric values corresponding to a driver status determination. At operation 606, the method 600 can generate a driver status data file indicating the driver status determination and configured for reception by one or more applications in communication with the controller.

It is to be understood that the specific order or hierarchy of steps in the method(s) depicted throughout this disclosure are instances of example approaches and can be rearranged while remaining within the disclosed subject matter. For instance, any of the operations depicted throughout this disclosure may be omitted, repeated, performed in parallel, performed in a different order, and/or combined with any other of the operations depicted throughout this disclosure.

Furthermore, the method 600 can include returning information from the wireless beacon devices 114, which can be Bluetooth® devices, such as the as the device's name, unique MAC address, which profiles the device support (e.g., Hands-Free), Bluetooth class (e.g., classic, Bluetooth® Low Energy (BLE), or dual), and/or the device's bonding state. The method 600 can also include listening for event changes in the Bluetooth connections which can indicate when the device has connected and disconnected, and can be matched against the known vehicle device, to determine the device status. Additionally, the occupant detection platform 102 can run in the background as services meaning that, once installed, the occupant detection platform 102 can process the connection events within the application automatically without any need for user intervention.

In some examples, the method 600 can also include approximating a distance between the computing device 106 and the wireless beacon devices 114 by comparing the expected signal strength threshold profile values 206, which can correspond to a known transmit power of the wireless beacon devices 114. In some examples, the occupant detection platform 102 can include a device fragmentation offset to provide increased accuracy via an offset may introduced to account for the differences in signal reception due to different hardware and phone cases. The occupant detection platform 102 can incorporate known factory calibrated transmit power for the determinations discussed herein. The method 600 of the occupant detection platform 102 can further include a sampling/smoothing operation and/or statistical filters to average the transmission signal over multiple measurements.

In some examples, operation 602 can include receiving data at the computing device 106 via an application installed on the computing device 106, such as an Android™ application. The application can be delivered in the vehicle 212 in multiple ways: via Android Auto which is a phone-based infotainment system presented at the screens of compatible vehicles; and/or via Android Automotive OS which is an infotainment platform bult into vehicles 212 and can be customized by vehicle manufacturers. For instance, an application (e.g., Android Auto) can open a set of input/output channels over which data is streamed response to the computing device 106 connecting to the in-vehicle infotainment (IVI), and can display applications compatible with the IVI, such as the occupant detection platform 102. Additionally or alternatively, the application can be installed directly into the head unit of the vehicle 212 (E.g., Android Automotive OS) and, as such, can access the resources and capabilities of the vehicle 212 (e.g., telematics data).

In some scenarios, to determine the one or more transmission metric values 116, the one or more predefined transmission arrangements 120, and/or to generate the driver status data file 302, the occupant detection platform 102 can receive data and/or send data to the various application(s) 403, which can comprise various types of applications. The types of applications can include a media application type, such as an audio media application which lets users browse and play music, radio, audiobooks, and other audio content in the vehicle 212. The types of applications can include a messaging application type, which lets users receive incoming notifications, read messages aloud using text-to-speech, and/or send replies via voice input in the car. The types of applications can include a navigation application type, which can include providers of driver and delivery services, and can help users get where they want to go by providing turn-by-turn directions. The types of applications can include a point of interest (POI) application type, which can let the user discover and navigate to points of interest and take relevant actions, such as parking, charging, and/or fueling. The types of applications can include an internet of things (IoT) application type, which can let users take actions on connected devices from within the vehicle 212, such as controlling the state of certain devices, opening a garage door, flipping home light switches, and/or enabling home security. The types of applications can include a video application type and/or a games application type for use while parked.

Furthermore, as discussed above, the permission controller 122 can include and/or has access to one or more API libraries, which can be organized into data structures particular to a phone manufacturer, an operating system, and/or the corresponding permission setting structures for those operating systems and app stores. For instance, the occupant detection platform 102 can access/manage an API library (e.g., the Android for Cars App library) configured for navigation applications, POI applications, IoT applications, which can be used to communicate with both mobile device-based applications and vehicle head unit-based applications. Furthermore, in some instances, the occupant detection platform 102 can be integrated into, layered onto, or otherwise can form a part of the other application(s) 403, such as a navigation application.

In some examples, the permission controller 122 can manage and/or access one or more vehicle hardware APIs in order for the occupant detection platform 102 to determine the one or more transmission metric values 116, the one or more predefined transmission arrangements 120, and/or to generate the driver status data file 302. For instance, a vehicle application library can provide access to vehicle properties and/or sensors (e.g., per OEM controls). These properties (e.g., which can be used as part of the driver detection calibration procedures 252 and/or by the data validation system 124) can include vehicle make, model, year, EV connector types, fuel types, toll card state, toll card type, battery level, fuel level, fuel level low, range remaining, raw speed, display speed, odometer distance, accelerometer, gyroscope, compass, location data, and/or combinations thereof. Furthermore, the vehicle hardware APIs can be divided into two main APIs: CarInfo (e.g., which manages access to car hardware specific info such as model, energy, and speed info) and CarSensors (e.g., which manages access to the vehicle's accelerometer, gyroscope, compass, and location data).

Additionally, the driver status data file 302 can be sent to the application(s) 403 to cause the application(s) 403 to perform one or more actions responsive to the driver status data file 302.

For instance, the driver status data file 302 can be sent to an application 403 operating at a connected home device to perform a monitoring alert such as locking a window or door, activating an electrical sensor, fire sensor, water sensor, and/or security camera. The action can be performed by a wearable device that receives the driver status data file 302, such as initiating a health monitoring procedure (e.g., glucose monitoring, a heartbeat monitor, etc.).

In some examples, the occupant detection platform 102 can operate as a foreground service which continues to run after the application initiating the service is closed. This can avoid various complexities due to different APIs while avoiding challenges related to a doze/standby mode. The occupant detection platform 102 can also generate and/or present one or more notifications indicating whether the occupant detection platform 102 is performing any data collection services and can provide an opt-out option. The permission controller 122 can perform permission requests and other permission activities to establish the foreground service status for the occupant detection platform 102.

As noted above, in some scenarios, the wireless beacon devices 114 include a Bluetooth Low Energy (BLE) beacon. This can be a small battery powered radio transmitter which constantly broadcasts a message (e.g., at periodic intervals). The message can include an identifier and additional information, such as a URL and/or a payload. The additional information can correspond to the particular manufacturer and/or manufacturer protocol for the beacon. In some instances, the beacon can include a proprietary protocol (e.g., Apple, Google, etc.), and/or the protocol can be open-source and/or customizable. Various parameters of the beacon can be adjusted to optimize the performance of the occupant detection platform 102, such as the content of the additional information, the timing frequency of transmission, and/or a power level. Settings values for these parameters can be accessed and/or stored by the occupant detection platform 102 to perform the operations discussed herein. Furthermore, the beacon can be a unit integrated with one or more other sensors or data-generating components, such as an accelerometer, gyroscope, a processor, a memory, and/or a clock, which can measure vehicle activity to be used by the data validation system 124 and/or the driver detection calibration procedures 252. In some examples, the beacon can be secured to a solid part of the car such as the car frame inside the driver compartment, the corner of the windshield, the dash, etc. The vehicle occupant detection system 100 can include beacons located at any combination of one or more driver side door(s), one or more passenger side door(s), the console, and/or the trunk.

Additionally, in some scenarios, the occupant detection platform 102 can determine the driver status for a first computing device in or near the vehicle 212 and a passenger status for a second computing device in or near the vehicle 212. In response to determining the driver status and the passenger status, the occupant detection platform 102 can select the first computing device for establishing a Bluetooth connection with the beacon (e.g., instead of the second device).

In some examples, the method 600 can include a scanning operation in which the computing device 106 starts a scan to look for devices matching a particular filter. The scanning operation can be initiated by an input received at the permission controller 122, such as a manual input at the mobile device 107 from the user. The particular filter can be used to specify the wireless beacon devices 114 by comparing the identifiers in the one or more transmission metric values 116 with identifiers stored at the computing device 106, while omitting other messages received at the wireless receiver 104 that do not match the particular filter. In some examples, the scanning operation can be initiated responsive to the occupant detection platform 102 being opened and/or running in the foreground. The scanning operation can be intermittent rather than continuous and can stop once the beacon is identified (e.g., to reduce power consumption).

In some examples, the wireless beacon devices 114 can include at least two beacon devices that both have a coverage range of the entire vehicle and/or overlapping coverage. Furthermore, the one or more transmission metric values 116 can be used to calculate an estimated distance in meters d between the computing device 106 and the wireless beacon device 114 using a path loss formula such as:

$$d = 1 {0}^{\frac{p - s}{10 n}}$$

with p equal to the beacon broadcast power in dBm at 1 meter (Tx Power); s equal to the measured signal value (RSSI) in dBm; and n being an environmental factor (e.g., between 2 and 4). Once one or a plurality of distances to the beacon(s) are known, the position of the computing device 106 in the vehicle 212 can be calculated (e.g., using Pythagorean's theorem). Additionally or alternatively, a curve fitting technique scan be used to calculate distances.

In some examples, the one or more transmission metric values 116 can include a Measured Power value, which can be a factory-calibrated constant indicating an expected signal strength at a particular distance (e.g., 1 meter). This transmission metric value 116 can be received from an advertising beacon data packet, which can be defined by the one or more wireless transmission protocols 118. Furthermore, the transmission power of the beacon can be calibrated to a high degree of accuracy to improve overall accuracy of the distance measurements. Distance measurement accuracy can also be improved by shortening the beacon advertising interval which can stabilize the signal. Statistical filters, signal processing, and/or sampling/smoothing to get an average result over multiple measurements can also reduce errors. Using a plurality of beacons, such as two, three, four, five, or six can further reduce errors in distance calculations. The number of beacons can also be less than ten, nine, eight, or seven to reduce interference between the beacons.

In some examples, the one or more transmission metric values 116 can include a direction value calculated by using two or more antennas (e.g., an antenna array). The direction value can be calculated using the time or phase difference of the detected signal. Furthermore, a continuous tone extension (CTE) added to the end of a BLE packet can be used to determine the direction value. The CTE can be a pure (e.g., unmodulated tone) which contains a sequence of binary one values, and can be long enough for the wireless receiver 104 to measure the phase difference.

For instance, the one or more wireless transmission protocols 118 can support at least two measurement methods including Angele of Arrival (AoA) and Angle of Departure (AoD). In the AoA mode, the wireless receiver 104 can have one antenna, and the receiver can multiple antennas (antenna array). The transmitter can constantly broadcast messages that contain the CTE. The receiver (e.g., the wireless receiver 104) can receive those messages and can use the CTE to calculate the phase difference of the received signal between the antennas. This can be done by switching between the different active antennas in the array. There can be a phase difference of signal of each antenna because of the distance between the antennas and the angle of the radio signal. In the AoD mode, the transmitter can have multiple antennas (e.g., antenna array) broadcasting simultaneously, and the receiver can have a single antenna. The transmitter can broadcast messages from multiple antennas at the same time that contain the CTE. The different signal message from the antennas in the array can arrive at the receiver's single antenna with a different phase shift. The phase difference can be due to the distance travelled from the transmitter antennas. In some examples, the angle of departure θ can be calculated using the measured phase difference ψ, the signal wavelength λ and the known distance between the antennas d as:

$$θ = arc cos ( ψλ / 2 π d )$$

While the present disclosure has been described with reference to various implementations, it will be understood that these implementations are illustrative and that the scope of the present disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A vehicle occupant detection system comprising:
a wireless receiver device obtaining a plurality of wireless transmissions from one or more wireless beacon devices positioned in a vehicle;
a controller having at least one processor, the controller determining one or more transmission metric values associated with the plurality of wireless transmissions, the one or more transmission metric values corresponding to a driver status determination; and
a driver status data file, generated by the controller, indicating the driver status determination, and the driver status data file is configured for reception by an application in communication with the controller.

2. The vehicle occupant detection system of claim 1, wherein:
the plurality of wireless transmissions includes one or more or an inquiry request, a discovery request, a pairing request, or a paging request.

3. The vehicle occupant detection system of claim 1, wherein:
the one or more wireless beacon devices include a plurality of Bluetooth low energy beacon devices having a predefined transmission arrangement in the vehicle, the driver status determination is based on determining whether the one or more transmission metric values meets a threshold profile value associated with the predefined transmission arrangement.

4. The vehicle occupant detection system of claim 3, wherein:
the threshold profile value includes a data structure, accessible by the controller, representing one or more expected signal strength values of the plurality of Bluetooth low energy beacon devices, the driver status determination is based at least partly on the one or more expected signal strength values.

5. The vehicle occupant detection system of claim 3, wherein:
the threshold profile value includes a data structure, accessible by the controller, representing one or more of an expected angle of departure value or an expected angle of arrival value for the plurality of wireless transmissions, the driver status determination is based at least partly on the expected angle of departure value or the expected angle of arrival value.

6. The vehicle occupant detection system of claim 3, wherein:
the driver status determination is based at least in part on the plurality of Bluetooth low energy beacon devices being positioned in the vehicle at two or more of:
a driver side dash location,
a passenger side dash location,
a driver side rear location, or
a passenger side rear location.

7. The vehicle occupant detection system of claim 6, wherein:
determining the one or more transmission metric values includes detecting a recurring connection pattern with a short-range, low energy beacon device at the driver side dash location, the driver side rear location, or a driver side door handle location.

8. The vehicle occupant detection system of claim 1, wherein:
the one or more wireless beacon devices are integrated into one or more of an onboard vehicle dash device or a door handle device.

9. The vehicle occupant detection system of claim 1, wherein:
the one or more transmission metric values include a first signal strength value associated with a first wireless beacon positioned in the vehicle, and a second signal strength value associated with a second wireless beacon positioned in the vehicle, the second signal strength value being lower than the first signal strength value.

10. The vehicle occupant detection system of claim 9, wherein:
the plurality of wireless transmissions includes a periodic ping request from the one or more wireless beacon devices for establishing a network connection.

11. A vehicle occupant detection system comprising:
one or more processors; and
a computer-readable non-transitory memory device storing instructions that, when executed by the one or more processors, cause the vehicle occupant detection system to:
receive, using a wireless receiver interface, one or more wireless transmissions from one or more wireless beacons positioned in a vehicle;
determine, using a controller, one or more transmission metric values associated with the one or more wireless transmissions, the one or more transmission metric values corresponding to a driver status determination; and
generate a driver status data file indicating the driver status determination and configured for reception by an application in communication with the controller.

12. The vehicle occupant detection system of claim 11, wherein:
the instructions, when executed by the one or more processors, further cause the vehicle occupant detection system to perform a driver detection calibration process by:
determining an identifier associated with a user of a mobile device including the wireless receiver interface;
establishing a network connection between the mobile device and at least one of the one or more wireless beacons; and
receiving a manual input at the mobile device to confirm a driver status associated with a transmission metric of the network connection.

13. The vehicle occupant detection system of claim 12, further comprising:
one or more near field communication tags positioned in the vehicle associated with a designated mobile device receiver area, wherein determining the one or more transmission metric values includes determining that a mobile device is placed in the designated mobile device receiver area.

14. The vehicle occupant detection system of claim 13, wherein:
the instructions, when executed by the one or more processors, further cause the vehicle occupant detection system to present an indication, at a display of the mobile device, of the designated mobile device receiver area associated with the one or more near field communication tags designated to the driver status.

15. The vehicle occupant detection system of claim 11, wherein:
the instructions, when executed by the one or more processors, further causes the vehicle occupant detection system to send the driver status data file to the application in communication with the controller based at least partly on a permissions action of the application.

16. The vehicle occupant detection system of claim 15, wherein:
the application includes one or more of a public transportation ticketing application, a ride sharing application, or an insurance application.

17. A method of vehicle occupant detection, the method comprising:
receiving, using a wireless receiver interface of a computing device, one or more wireless transmissions from one or more wireless beacons positioned in a vehicle;
determining, using a controller of the computing device, one or more transmission metric values associated with the one or more wireless transmissions, the one or more transmission metric values corresponding to a driver status determination; and
generating a driver status data file indicating the driver status determination and configured for reception by one or more applications in communication with the controller.

18. The method of claim 17, wherein:
the one or more wireless transmissions include a request to establish a network connection; and
generating the driver status data file includes a data conversion procedure performed by:
converting signal strength data or signal angle data from the request to establish the network connection into the one or more transmission metric values, and
converting the one or more transmission metric values into the driver status data file formatted for reception by the one or more applications.

19. The method of claim 18, wherein:
the data conversion procedure omits establishing the network connection with the one or more wireless beacons responsive to the request.

20. The method of claim 17, further comprising:
receiving device activity data from the one or more applications including a user behavior indicator, wherein generating the driver status data file includes performing a data verification procedure by comparing the user behavior indicator to the driver status determination.
